(19) United States
(12) Patent Application Publication
(10) Pub. No.: US 2026/0119100 A1
(43) Pub. Date: Apr. 30, 2026

(54) MULTI-THREADED SIGNAL QUEUING FOR PRINTING

(71) Applicant: KYOCERA Document Solutions Inc., Osaka (JP)

(72) Inventor: Sam Chinh Co Tang Chan, Garden Grove, CA (US)

(21) Appl. No.: 18/932,550

(22) Filed: Oct. 30, 2024

(51) Int. Cl. G06F 3/12

(52) U.S. Cl. CPC G06F 3/1269; G06F 3/1205; G06F 3/1254; G06F 3/1259; G06F 3/127; G06F 3/1288

(57) ABSTRACT

Systems and methods relate generally to printing. In a method, a job manager of a printing device DFE receives a print job. An exchange job definition formatted client (“client”) subscribes to receive associated signal information. The job manager provides the print job to a printer engine of the DFE. An exchange job definition message (“message”) associated with the print job is queued in a message queue of the DFE. The message queue and a signal queue are monitored by a task monitor of the DFE. The message is passed from the message queue to a task processor of the DFE. The message is processed responsive to content thereof by the task processor. A subscription for the client is received via the task processor by a subscription manager of the DFE. A combined message is created by the subscription manager using the subscription and an associated address for the client.

### FIELD

The following description relates to printing. More particularly, the following description relates to multi-threaded signal queuing for printing.

### BACKGROUND

Generally, a Job Definition Format (JDF) or an Exchange Job Definition Format (XJDF) is from a CIP4 organization specification and solution for print-workflow automation for different vendors. Exchange Job Message Format (XJMF) and Job Message Format (JMF) are detailed communication protocols using XML (Extensible Markup Language) technology. XJMF defines synchronized in query and asynchronized signal messaging. Accordingly, enhancing throughput of an XJDF implementation is both desirable and useful.

### SUMMARY

In accordance with one or more below described examples, a method relating generally to a printing device is disclosed. In such a method, a print job is received by a job manager of a digital front end of the printing device. An exchange job definition formatted client (“client”) subscribes to receive associated signal information regarding the print job. The print job is provided under control of the job manager to a printer engine and task report device of the digital front end. An exchange job definition message is queued for a printing thread associated with the print job in a message queue of the digital front end for a forward path to the client. The message queue and a signal queue are monitored by a task monitor of the digital front end. The exchange job definition message is passed from the message queue to a task processor of the digital front end. The exchange job definition message is processed responsive to content thereof by the task processor. A subscription for the client is received via the task processor by a subscription manager of the digital front end. A combined message is created by the subscription manager using the subscription and an associated address for the client.

In accordance with one or more below described examples, a system relating generally to printing is disclosed. In such a system, there is a printing device having a memory configured to store program code and a processor coupled to the memory. In combination and response to executing the program code, the printer system is configured to initiate operations for implementing a process for printing, the process includes: receiving a print job by a job manager of a digital front end of the printing device; subscribing by an exchange job definition formatted client (“client”) to receive associated signal information regarding the print job; providing the print job under control of the job manager to a printer engine and task report device of the digital front end; queuing an exchange job definition message for a printing thread associated with the print job in a message queue of the digital front end for a forward path to the client; monitoring the message queue and a signal queue by a task monitor of the digital front end; passing the exchange job definition message from the message queue to a task processor of the digital front end; processing the exchange job definition message responsive to content thereof by the task processor; receiving a subscription for the client via the task processor by a subscription manager of the digital front end; and creating a combined message by the subscription manager using the subscription and an associated address for the client.

Other features will be recognized from consideration of the Detailed Description and Claims, which follow.

### BRIEF DESCRIPTION OF THE DRAWINGS

Accompanying drawings show exemplary apparatus(es) and/or method(s). However, the accompanying drawings should not be taken to limit the scope of the claims, but are for explanation and understanding only.

FIG. 1 is a block-flow diagram depicting an example of a printing workflow for a printing system.

FIG. 2 is a flow diagram depicting an example of a data operations flow for the printing workflow of FIG. 1.

FIG. 3 is a block-pictorial diagram depicting an example of a networked system.

FIG. 4 is a pictorial diagram depicting an example of a network.

FIG. 5 is a block diagram depicting an example of a portable communication device.

FIG. 6 is a block diagram depicting an example of a multi-function printer (MFP).

FIG. 7 is a block diagram depicting an example of a computer system.

### DETAILED DESCRIPTION

In the following description, numerous specific details are set forth to provide a more thorough description of the specific examples described herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same number labels are used in different diagrams to refer to the same items; however, in alternative examples the items may be different.

Exemplary apparatus(es) and/or method(s) are described herein. It should be understood that the word “exemplary” is used herein to mean “serving as an example, instance, or illustration. ” Any example or feature described herein as “exemplary” is not necessarily to be construed as preferred or advantageous over other examples or features.

Before describing the examples illustratively depicted in the several figures, a general introduction is provided to further understanding.

In a conventional document handling system, a printer or printer system may receive print job settings (“job settings”) from a printer driver (“driver”). In another example, job settings might not be provided from a driver. In either example, a print job output may be delayed waiting for another print job output from a printer system.

A printer system, like a computer, may operate under a network protocol. For a printer system, a Samba protocol, file transfer protocol (“FTP”), Server Message Block (“SMB”) protocol, Web Distributed Authoring and Versioning (“WebDAV”) extensions to a Hypertext Transfer Protocol (“HTTP”), or other printer system usable protocol may be used where one or more folders may be shared via such protocol. A “hot folder” or “hotfolder” may be a printer shared network folder, and this hotfolder may have files associated with it. For purposes of clarity by way of example and not limitation, in the following description an SMB hotfolder job for a print job in such a hotfolder is used, even though other protocol examples may be used.

A digital front end (DFE) is an appliance designed to drive a print engine of a printer system. A DFE may accept a print file, such as for example a portable document format (PDF) or PostScript file, and interpret that file to convert it into a format that a print engine (such as for example a toner or inkjet print engine) can use to “lay down”content on a substrate, such as paper for example.

A DFE may include a print engine, such as including a Raster Image Processor (RIP), and may provide additional functionality depending on printer system. Sites using AFP, Xerox Metacode, XSL-FO files, HP-PCL files or similar formats have generally the same workflow as using PostScript or PDF, and so a PDF workflow is described for purposes of clarity by way of example and not limitation. Generally, an printer engine interprets an inbound file, conventionally one page at a time, and renders a continuous tone bitmap based on directions of such file. Conventionally, a printer engine creates a screened file ready for use. Different printer system vendors may have their own sets of algorithms designed to tune screening to their print engine, so files sent to different machines may render differently.

In a workflow, a DFE may manage color, ICC profiles, paper catalog, imposition, and handle variable data. DFEs on production inkjet devices may include options for setting ink levels and managing options for drying levels and print speeds. Some production devices may offer more than one approved DFE, having different features and functions sets, supported file formats, print speeds, automation levels, and communications between workflows for example, from which a user can select for their workflow.

As described below in additional detail, an XJDF and its associated messaging protocol XJMF (or JDF and its associated messaging protocol JMF) may be used as a printer communication protocol. For purposes of clarity by way of example and not limitation, the following description is for XJDF, even though other information exchange interfaces may be used. XJMF describes an interface between management applications and applications that execute instructions, namely generally a pure information-interchange interface. For a SMB hotfolder job, such a file may indicate directions for a workflow to executed by a DFE. An XJMFmay provide a set of status query/signals associated with a XJDF/print job-ticket handed off from a management application to a DFE.

Exchange of information may include a device resource, device status and print job. An application can subscribe for a device resource, device status, and print job signaling. When a print job is submitted, signals may post to an XJDF/XJMF client. For example, a print job may have “SignalStatus” and “SignalNotification” signals. For example, for SignalStatus there may be indicators for job received, job resource download begin/end, job RIP, job print, or job finishing, among others depending on a workflow for an associated print job.

For a small number of SMB hotfolder jobs copied thereto, printer system sending status signaling for each slowing an XJDF client generally is not problematic. However, if a large number of SMB hotfolder jobs are copied thereto, namely representing 10K or more bytes of print job status signaling, printer system sending status signaling for each slowing an XJDF client may be problematic. Along those lines, a problem may result due to congestion of workflow signaling. Additionally, this amount of workflow signaling may result in a substantial amount of system memory being allocated. This may result in an XJDF client or a printer system UI having substantial delay in processing current print job data due to a backlog of older print job data. In some instances, this has resulted in an XJDF client being nonresponsive.

As described below in additional detail, to deal with backlog and to reduce memory usage, multi-threaded signal queuing may be used. Each signal queue may be generated on-demand for an associated virtual address. If a system is completely full, rather than continuing to write to memory queues in such a system and crashing the system, a clean mode may be initiated to clear queues and repopulate with one large message instead of many small messages.

With the above general understanding borne in mind, various configurations for systems, and methods therefor, for printing, or more particularly a printing status workflow, are generally described.

Reference will now be made in detail to examples which are illustrated in the accompanying drawings. In the following detailed description, numerous specific details are set forth in order to provide a thorough understanding of the following described implementation examples. It should be apparent, however, to one skilled in the art, that the implementation examples described below may be practiced without all the specific details given below. Moreover, the example implementations are not intended to be exhaustive or to limit scope of this disclosure to the precise forms disclosed, and modifications and variations are possible in light of the following teachings or may be acquired from practicing one or more of the teachings hereof. The implementation examples were chosen and described in order to best explain principles and practical applications of the teachings hereof to enable others skilled in the art to utilize one or more of such teachings in various implementation examples and with various modifications as are suited to the particular use contemplated. In other instances, well-known methods, procedures, components, circuits, and/or networks have not been described in detail so as not to unnecessarily obscure the described implementation examples.

For purposes of explanation, specific nomenclature is set forth to provide a thorough understanding of the various concepts disclosed herein. However, the terminology used herein is for the purpose of describing particular examples only and is not intended to be limiting. As used herein, the singular forms “a”, “an” and “the” are intended to include the plural forms as well, unless the context clearly indicates otherwise. As used herein, the term “if” may be construed to mean “when” or “upon” or “in response to determining”or “in response to detecting,”depending on the context.

Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. It will also be understood that the term “and/or” as used herein refers to and encompasses any and all possible combinations of one or more of the associated listed items. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof. It will also be understood that, although the terms first, second, etc., may be used herein to describe various elements, these elements should not be limited by these terms, as these terms are only used to distinguish one element from another.

Some portions of the detailed descriptions that follow are presented in terms of algorithms and symbolic representations of operations on data bits, including within a register or a memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those involving physical manipulations of physical quantities. Usually, though not necessarily, these quantities take the form of optical, electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers or memories into other data similarly represented as physical quantities within the computer system memories or registers or other such information storage, transmission or display devices.

Concepts described herein may be embodied as apparatus, method, system, or computer program product. Accordingly, one or more of such implementation examples may take the form of an entirely hardware implementation example, an entirely software implementation example (including firmware, resident software, and micro-code, among others) or an implementation example combining software and hardware, and for clarity any and all of these implementation examples may generally be referred to herein as a “circuit,” “module,” “system,” or other suitable terms. Furthermore, such implementation examples may be of the form of a computer program product on a computer-usable storage medium having computer-usable program code in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (“RAM”), a read-only memory (“ROM”), an erasable programmable read-only memory (“EPROM” or Flash memory), an optical fiber, a portable compact disc read-only memory (“CD-ROM”), an optical storage device, a transmission media such as those supporting the Internet or an intranet, or a magnetic storage device. The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (“RF”) or other means. For purposes of clarity by way of example and not limitation, the latter types of media are generally referred to as transitory signal bearing media, and the former types of media are generally referred to as non-transitory signal bearing media.

Computer program code for carrying out operations in accordance with concepts described herein may be written in an object-oriented programming language such as Java, Smalltalk, C++ or the like. However, the computer program code for carrying out such operations may be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (“LAN”) or a wide area network (“WAN”), or the connection may be made to an external computer (for example, through the Internet using an Internet Service Provider).

Systems and methods described herein may relate to an apparatus for performing the operations associated therewith. This apparatus may be specially constructed for the purposes identified, or it may include a general-purpose computer selectively activated or reconfigured by a computer program stored in the computer.

Notwithstanding, the algorithms and displays presented herein are not inherently related to any particular computer or other apparatus. Various general-purpose systems may be used with programs in accordance with the teachings herein, or it may prove convenient to construct a more specialized apparatus to perform the operations. In addition, even if the following description is with reference to a programming language, it should be appreciated that any of a variety of programming languages may be used to implement the teachings as described herein.

One or more examples are described below with reference to flowchart illustrations and/or block diagrams of methods, apparatus (including systems) and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the Figures illustrate the architecture, functionality, and operation of possible implementations of apparatuses (including systems), methods and computer program products according to various implementation examples. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

It should be understood that although the flow charts provided herein show a specific order of operations, it is understood that the order of these operations may differ from what is depicted. Also, two or more operations may be performed concurrently or with partial concurrence. Such variation will depend on the software and hardware systems chosen and on designer choice. It is understood that all such variations are within the scope of the disclosure. Likewise, software and web implementations may be accomplished with standard programming techniques with rule-based logic and other logic to accomplish the various database searching operations, correlation operations, comparison operations and decision operations. It should also be understood that the word “component” as used herein is intended to encompass implementations using one or more lines of software code, and/or hardware implementations, and/or equipment for receiving manual inputs.

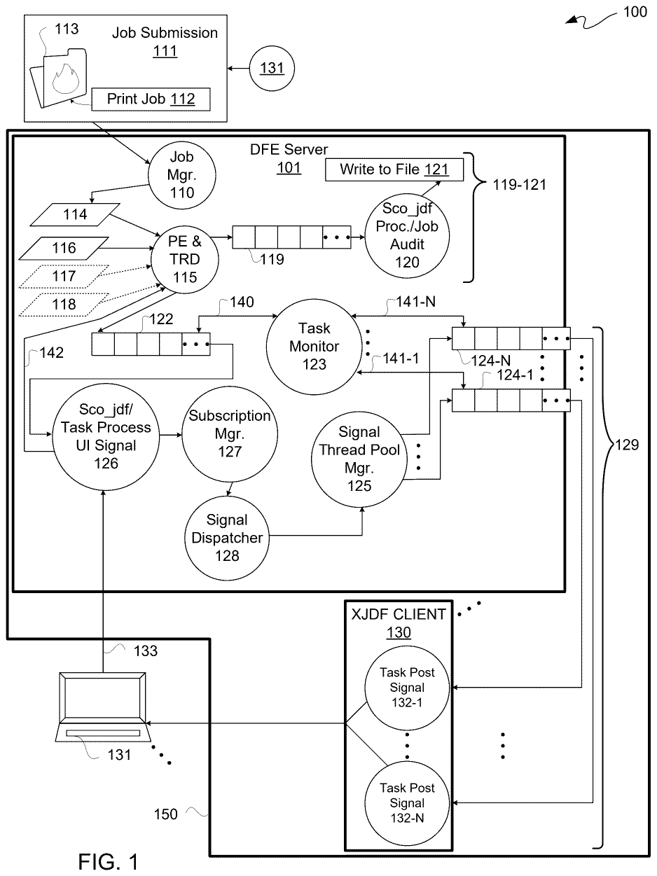

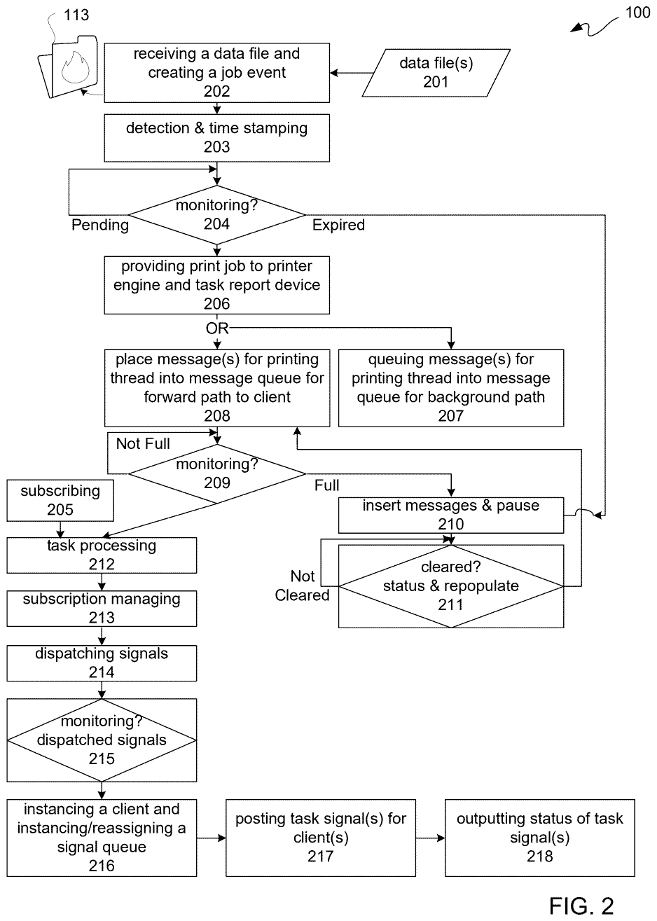

FIG. 1 is a block-flow diagram depicting an example of a printing workflow 100 for a printing system. Such a printing system may include a printing device 150 in communication with one or more user devices. Such a printing device may be networked, as described below in additional detail. FIG. 2 is a flow diagram depicting an example of a data operations flow 200 for printing workflow 100 of FIG. 1. With simultaneous reference to FIGS. 1 and 2, printing workflow 100 and data operations flow 200 are further described.

DFE server 101 of printing device 150 provides a front end to one or more exchange job definition formatted clients 130 of such printing device. In this example, each of such exchange job definition formatted clients is an XJDF client 130, which in this example is a website or other web presence. DFE server 101 may reside internal to a printing device 150, and such printing device 150 may provide script for such one or more XJDF clients 130 to a website or web presence.

DFE server 101 may be in communication with a user device, such as a personal computer 131, smart phone, tablet, or another electronic device. A printer API call may be used to communicate between an application running on personal computer (“PC”) 131 and a printing device 150.

At operation 111, a print job file (“print job”) 112, such as for example a user copy of a file for a print job, may be submitted as a print job by providing to a hot folder (“hotfolder”) 113 in communication with a job manager 110 of DFE server 101. Such a print job 112 may, for example, be submitted via FTP, LPR, http (XMF, XJDF), raw TCP/IP (port 9100), or other print job streaming. In this example, a printing device 150 is networked via an SMB protocol; however, as previously indicated, another type of protocol may be used in other examples. Accordingly, hotfolder 113 may be an SMB hotfolder accessible by DFE server 101, namely a shared networked folder via an SMB protocol in this example. Such print job 112 may be submitted by job submission operation 111 from a PC 131 for example.

In response to providing a copy of a print job file or one or more data files 202 to a hotfolder 113, a job event is automatically created at 202 by such hotfolder for such print job 112. A print job may be automatically submitted to a printing device to print corresponding to a job event therefor, where such a job event may be queued in hotfolder 113 and submitted to a job manager 110 of DFE server 101 along with an associated print job 112 in communication with hotfolder 113 to automatically processes each.

At operation 203 presence of a print job or other data file in hotfolder 113 may be automatically detected and a job event created therefor may be timestamped, such as by programming of hotfolder 113. At operation 204, such a print job or other data file, or job event therefor, may be monitored in such hotfolder 113 to determine if same is either pending or expired, the latter of which may be based on time delay from such timestamp. If pending, job manager 110 may let such print job stay in a queue in hotfolder 113 of print jobs until DFE 101 can process such print job. If, however, DFE 101 is unable to process another print job due to an out of memory or other issue, as described below in additional detail, then an expiration state may result, as described below in additional detail. Along those lines, by design, a hotfolder 113 may not have an expired print job; however, out of precaution, an expired state detected at operation 204 may cause a temporary pause at operation 210, as described below in additional detail.

An XJDF client 130, which may be Web-UI or Application-UI viewable on a screen or otherwise accessible via a user personal computer 131, may subscribe at operation 205 by asserting subscription signal 133, namely a client PC subscribe for signal for example, for XJDF signal information, such as to receive device status signaling and job status signaling for a print job 112. In this example, client PC 131 asserts subscription signal 133 to an Sco_jdf/Task Process UI Signal function 126 (“Sco” is an internal designation without any relevant meaning) of DFE server 101. An API may be passed along via API call signal (“API call”) 142, as described below in additional detail.

Generally, a DFE accessible hotfolder 113 may be used to create a job event and resources which may be sent to an XJDF client 130, as described below in additional detail. Receipt of a print job 112 triggers hotfolder 113 to make print job data available to job manager 110, which in turn may manage a queue for print jobs in such hotfolder. Job manager 110 may allow such print job data 114 to move into DFE 101 to a printer engine and task report device (PE&TDR) 115 thereof. Additionally, PE&TRD 115 may receive information from an XJDF channel 116.

Optionally, rather than copying a print job 112 into an SMB hotfolder, an LPR channel 117 may be used to directly provide print job data for execution of a print job by PE&TRD 115. Optionally, rather than copying a print job 112 into an SMB hotfolder, print job data for a print job may be directly streamed to PE&TRD 115, such as via an FTP channel 118 or a raw TCP/IP port (not shown) for example. For example, a group of files may be copied to an FTP location for such streaming. Accordingly, print job data 114 may be received by PE&TRD 115 as an SMB print job, an FTP print job or an LPR print job for example. However, for purposes of clarity by way of example and not limitation, it shall be assumed that an SMB print job via an SMB hotfolder is used, even though other types of channels for providing a print job to a PE&TRD may be used.

Generally, PE receives print job data 114 and TRD reports on print job data 114 received by PE. Examples of XJDF channel data may include one or more of SignalStatus, SignalQueueStatus, SignalNotification, SignalResource, or SignalKnownDevice, among other signals. A printing device may send XJMF messages, such as SignalResource, SignalSatus, SignalQueueStatus, ReturnQueueEntry (Signal), or SignalNotication, among other messages.

When a task of a print job is completed, signals can be posted, such as SignalStatus, SignalQueueStatus, and ReturnQueueEntry, among others. One or more of these signals may be posted to XJDF client 130.

XJDF client 130 may subscribe for signaling (“Signal”) via an HTTP protocol or other networking protocol at operation 205. Signaling may be classified as Reliable or FireAndForget, and XJMF messaging in return may be entered via QueueEntry as reliable, FireAndForget, or another signal. Along those lines, signals that may for example be subscribed to may include one or more of: Subscribe SignalResource; Subscribe SignalQueueStatus/Change only; Subscribe SignalStatus/Job Change only (Job add/remove/update); or Subscribe SignalStatus/All Job list.

These and other examples of XJDF signals and information, as well as XJMF messages, are well described in the CIP XJDF specification therefor, and thus are not described in unnecessary detail herein. In this example, c/c++ class/structure raw data is used; however, in other examples other languages or structures may be used.

A printing device starts with a low level Register/Callback to Sco_jdf module for JobStatus Signal Data. Raw Structure/JobStatus data may be put on an Internal BD-JA-Task (BackGround-JobAudit)-Queue, a UI-SignalTask-Queue, or Sco_jdf (BG-JA), and grabbed data may be stored for each job data in XJDF audit file.

Sco_jdf (UI-SignalTask) may grab x number of data from a queue and find a corresponding XJDF subscription to make an associated signal for each online subscription. An online subscription means an XJDF client is on a network and ready to receive post messaging. In some instances, there may be combination or multiplexing of multiple raw signals into one XJMF signal, and so such a message can then be sent in a larger blob or chuck, if possible. Such combination may be a multiple SignalStatus or a combination of SignalStatus and SignalNotifiation. As long as a combined message is heading to a same XJDF Client 130, a combine message facilitates more throughput, namely better in performance.

PE&TDR 115 may place or queue one or more messages for various printing threads into either of messaging queues 119 or 122 of DFE 101 depending on what such messages are for. For example, a message for a printing thread associated with print job 112 may be queued or placed in a message queue 119 for a job audit function. These messages may follow an XJMF protocol for an XJDF client as in this example; however, another messaging protocol may be used in another example.

Messages placed into messaging queue 119 may be for a XJDF or JDF process 120, such as for example an Sco_jdf process, of DFE 101. Additionally, messages placed into messaging queue 119 may be for a background job audit function 120.

Depending on type of raw data, protocol or other variable used in execution of a print job, different types of messages may be used. So for example for handling of writing background data to an XJDF file, a message for writing to file may be placed into messaging queue 119 for a background job audit function 120 for a write to file operation 121. For example, if an XJDF file is to be printed, the number of pages for such a print job is stored, and this information may be recorded as background in a write to file operation 121 in response to a message for same.

By providing a path 119-121 for corresponding operations, these operations, such as for example background operations, are not in or not part of a forward path to an XJDF client. In other words, user interface, UI or UX, is not bogged down with background and other 119-121 path data. This diversion of these types of data enhances operational throughput for an XJDF client path.

The remainder of this description, such as for print job status via XJDF signaling, is for a lower print job to XJDF client path or client forward path 129 in contrast to an upper generally background path 119-121 out of such forward path.

PE&TDR 115 may place messages for an XJDF client, such as for example XJDF client 130, in message queue 122. From message queue 122 of DFE server 101 to XJMF signal queue 124-1 through 124-N for N a positive integer (singly and collectively “signal queues 124”), therebetween is a task monitor 123 generally for monitoring signal size.

Task monitor 123 of DFE 101 is in control signal communication with each of XJMF signal queues 124 of DFE 101 via control signals 141-1 through 141-N, respectively, and with message queue 122 via control signaling 140 for monitoring both message queue 122 and each of signal queues 124 at operation 209. Along those lines, task monitor 123 may ping each of those queues with a control signal to have them respond with a depth of queue status signal. Such a depth of queue signal provides an indication as to how full each of such queues is. In an example, a maximum depth of queue for each of such queues may be a limit on a supported configuration. For example, task monitor 123 may check for a size of an output XJMF signal or internal raw data signal. If a QueueSize value has reached a limit, task monitor 123 may clear a FireAndForget signal message and an internal Raw_FireAndForget raw message and may prepare an AllJob signal message, as described below in additional detail at operation 210. Basically, a task monitor 123 may insert a start clean up message at the beginning of message queue 122 and an end clean up message at the end of message queue 122 at operation 210, with the former message starting a clean-up process and the latter message, when reaching the end of such message queue 122, ends such a clean-up process for a targeted signal queue 124.

Additionally, PE&TDR 115 is prevented or paused at operation 210 from sending any more messaging to such targeted signal queue 124, which may be more than one queue for an XJDF client 130, during such a clean-up process, as described below. Once a targeted signal queue 124 is cleared as determined at operation 211, such signal queue may be re-activated for messaging in response to such cleared state, namely after a message therefor has moved out of message queue 122. This allows such signal queue 124 to be repopulated by downstream operation of PE&TDR 115 at operation 211. This reactivation may cause PE&TDR 115 to in effect take a “snapshot” of status of all print jobs in a DFE 101 for such an XJDF client 130, and put such an all jobs snapshot onto message queue 122 for repopulating such targeted signal queue 124, as described in additional detail below for an XJDF protocol example, by downstream data flow along forward path 129.

In addition to depth of an XJMF signal queue 124, there may be a limit by an XJMF protocol on the number of threads or XJMF signal queues 124 that may be present at the same time. In this example, there is a one-to-one correspondence between XJMF signal queues 124 and active personal computer virtual addresses (PC) or Uniform Resource Locators (URLs). For purposes of clarity, an example of URLs is used; however, it should be appreciated that other forms of virtual addresses may be used.

In this example, each signal queue 124 may be instantiated on an on-demand basis for each URL by providing a subscription from operation 205 to a task processor 126 at operation 212. Each signal queue 124 may operate for a corresponding XJDF signal client, such as XJDF client 130 for example. If there are multiple XJDF signal clients operating at a time, and one of such XJDF signal client finishes, then such associated signal queue 124 may be returned to a pool of such queues as described below in additional detail. However, if an XJDF client finishes and a signal queue 124 therefor is returned to a pool as determined at operation 215, a signal thread pool manager 125 may have instanced another XJDF client at operation 216 before a signal queue 124 is assigned to it at operation 216, and so it is possible to have a state with more XJDF clients than active corresponding signal queues. If a pool of queues is empty, a signal queue 124 having finished for an XJDF client, namely no more XJMF signal queue messages in such queue, may be reassigned at operation 216 to another XJDF client without re-instancing for efficiency. Signal thread pool manager 125 may monitor at operation 215 for an XJDF client finishing.

For each XJMF signal queue 124-1 through 124-N, there is a corresponding task post signal 132-1 through 132-N of an XJDF client 130 external to DFE server 101. Effectively, XJMF signal queues 124 provide and interface of DFE server 101 to XJDF client 130 for posting at operation 217, as previously described.

Again, XJDF describes an interface between management applications and applications that execute instructions, namely generally a pure information-interchange interface. For a SMB hotfolder job, such a file may indicate directions for a workflow to executed by a DFE. An XJDF may provide a set of status signals associated with a print job-ticket handed off from a management application to a DFE. Along those lines, each task post signal 132 may indicate whether a task has completed for generation of a status signal state for such task, and each such task post signal 132 may be provided to a user, such as for example PC 131, at operation 218.

Task monitor 123 can monitor signal queues 124 as well as message queue 122 at operation 204. Task monitor 123 does not inform on whether a signal queue 124 is available, rather signal thread pool manager 125 merely assigns signal queues on an on demand basis and reassigns a signal queue if finished with a then current XJDF client at operation 216. Moreover, signal thread pool manager 125 manages signal queues 124 for each XDJF client URL. If a signal queue 124 is empty for an XJDF client URL meaning finished, then signal thread pool manager 125 may reassign such signal queue 124 for use for a different XJDF client URL. If there is at least one signal queue 124 of N possible queues available, signal thread pool manager 125 may create or instantiate such an available signal queue on demand for an XJDF client URL anew. Reassigning a signal queue 124 is more efficient than creation, so reassignment takes priority over instantiation if such a condition is presented.

For example, a signal for a URL/Subscription may be queued to one a Queue Post Signal Task/Thread (thread pool). There may be more than one of Queue Post Signal when multiple XJDF clients are active. A Post Signal Task may take each signal and send it one-by-one to an associated XJDF client. Generally, an XJDF client application is not a bottleneck issue, as it receives a message quickly and displays for example the date on GUI quickly. A bottleneck issue may arise with an XJDF client with a webpage accepting HTTP posted data, as this may be slow and such data may be consumed slowly, as conventionally such data processing task is written in JavaScript.

Signal thread pool manager 125 is coupled to each of signal queues 124 for providing messages thereto, in contrast to task monitor 123 which is coupled to each of signal queues 124 to determine a current signal size. If a current signal size reaches a threshold value, then task monitor 123 can operate as previously described to disable and clean up message queue 122.

Task monitor 123 may monitor both DFE internal UI-Queue, namely message queue 122, and each Queue Post Signal (one per URL), namely each signal queue 124. When queue data of any of such queues reaches a defined limit, task monitor 123 may insert a begin clear and end clear message to such queue. This may trigger a Thread Message Process/Task to find a message associated with such queue and start a disable of such queue and prevent such queue from queuing up any raw UI message information, and start a cleanup internal FireAndForget message and queue a Post Signal Queue's message. When a last message of such queue is cleared, such queue with then be reactivated to allow queuing up of raw UI message information, and depending on a subscription, such queue may send and get all job SignalStatus/SignalQueueStatus.

Task monitor 123 allows information for all jobs to propagate to create all job XJMF and queue messaging to a Queue Post Signal Pool, namely any and all active signal queues 124. A large blob or chunk of all job XJMF messages may be sent to one or more signal queues 124 for an associated XJDF client 130 rather than sending many small messages. This large blob or chunk may be asserted in response to a completed cleanup so a repeat message does not have to be sent for each previously cleaned message. A post for a URL may have an additional parameter to inform an XJDF Client 130 that these messages in such large blob or chunk is a complete replacement of any and all prior messages, so an XJDF client 130 side of an XJMF message queue does not need to clear any space for such blob or chunk, namely clearing of any and all associated signal queues 124 for such an XJDF client 130 has already been completed.

Output from message queue 122 may be provided as an input to Sco_jdf/Task Process UI Signal function (task processor) 126 at operation 212.

Examples of such messages output from message queue 122 may be to inform task processor 126 to process such XJMF message for normal operation, begin cleanup and disable incoming messaging, remove messages for such cleanup, end cleanup and remove URL message, or re-activate incoming messaging and call to resend an all job message signal. Task processor 126 may receive a client PC subscription and associated information via subscription signal 133 from operation 205 to operation 212.

As an Sco_jdf DFE server has for each PC/URL subscription status of all print jobs within such server, as previously described, a snapshot may be taken of such status of an Sco_jdf DFE server for repopulating signal queues for an XJDF client 130. Task processor 126 may be in a normal passing of messages mode or may be in some state of a clean-up mode.

Task processor 126 of DFE 101 for a clean-up mode may make an application programming interface (API) call 142 to PE&TDR 115. This may be to cause PE&TDR 115 to stop or pause sending messages at operation 210 to a targeted signal queue 124 for a cleanup and to restart sending messages to a targeted signal queue 124 after completion of cleanup, such as determined at operation 211. With respect to the latter, an API call 142 from task processor 126 to PE&TDR 115 may be to provide a snapshot of status of all print jobs for operation 211 repopulation for an XJDF client 130 and send same as a large message blob or chunk to message queue 122.

Task processor 126 receives messages from message queue 122. A message provided via message queue 122 may be to start cleanup, namely a message put in such queue by task monitor 123. Another message provided via message queue 122 may be to end cleanup, namely a message put in such queue by task monitor 123. Accordingly, task processor 126 may act on messaging received by message queue 122, including those for a clean-up mode, namely begin cleanup and disable incoming messaging, remove messages for such cleanup, end cleanup and remove URL message, or re-activate incoming messaging and call to resend an all job message signal. Task manager 126 may assert respective API calls to PE&TDR 115 for disable incoming messaging and re-activate incoming messaging, and to call to resend an all job message signal.

Some messages might not be cleared during a clean-up mode by task manager 126. For example, FireAndForget and Reliable messages are not cleared by task manager 126 but are sent to an XJDF client. However, for a Signal Post fail by task processor 126, a URL may be marked as offline, and so all FireAndForget and Reliable messages may be cleared. For a Signal Post Success, Reliable Messages may be marked as sent or sent fail, otherwise such Reliable Messages will be sent again when a URL is found to be online. Determining if a URL is online may be handled by a which URL monitor task performed by task manager 126.

Output of task processor 126 is provided to subscription manager 127 of DFE 101. At operation 213, subscription manager 127 manages subscription, such as obtaining a subscription and creating a combined message with subscription information and an associated URL or other network or virtual address. A message may additionally include a device identifier and other XJMF message information. An XJMF Signal may be combined into such message too.

Output of subscription manager 127 is provided to signal dispatcher 128 of DFE 101 at operation 214, and out of signal dispatcher 128 is provide to thread pool manager 125 of DFE 101 at operation 215. At operation 214, signal dispatcher 128 dispatches signals from XJMF messages created by subscription manager 127, and such dispatched signals are provided to thread pool manager 125 at operation 215 for signal queues 124, as previously described.

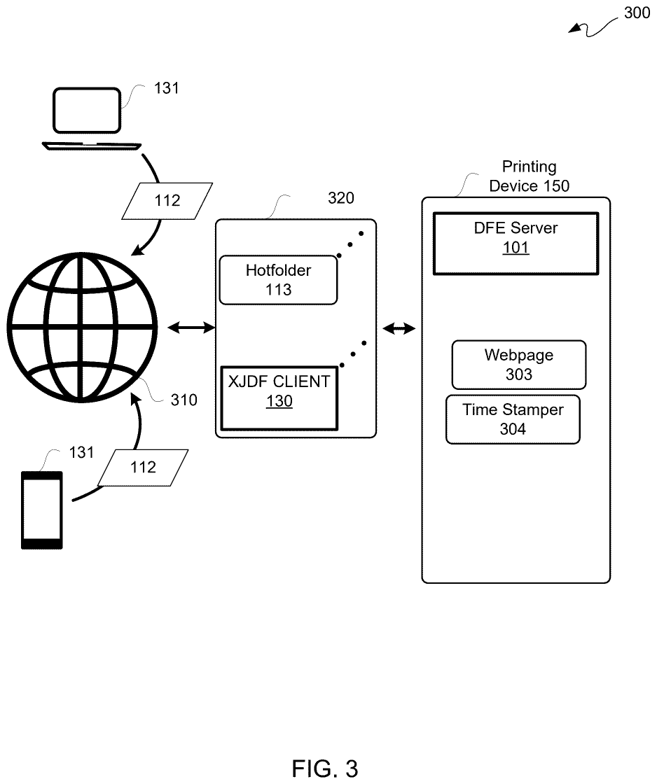

FIG. 3 is a block-pictorial diagram depicting an example of a networked system 300. User devices 131 may provide print jobs 112 to a network, such as the Internet 310 or other network. Printing device 150 may be in communication with user devices 131 via the Internet 310 and a network appliance 320.

Network appliance 320 may be in communication with the Internet 310 and printing device 150. Along those lines, a subscription signal 133 of FIG. 1 may be provided from a user device 131 to a DFE server 101 via the Internet 310, which may pass through network appliance 320. Network appliance 320 may be a virtual space.

Network appliance 320 may be used to instantiate one or more hotfolders 113 and one or more XJDF clients 130. Network appliance 320 may be in communication with printing device 150. Printing device 150 may include a DFE server 101. Optionally, printing device may include a webpage 303 and a time stamper 304.

Because one or more of the examples described herein may be implemented using an information processing system, a detailed description of examples of each of a network (such as for a Cloud-based SaaS implementation), a computing system, a mobile device, and an MFP is provided. However, it should be understood that other configurations of one or more of these examples may benefit from the technology described herein.

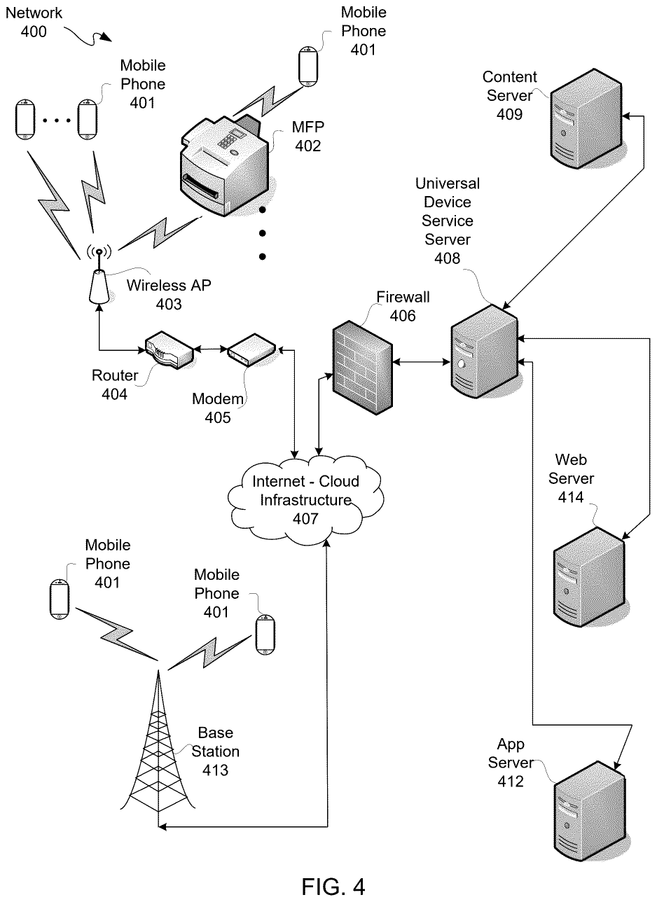

FIG. 4 is a pictorial diagram depicting an example of a network 400, which may be used to provide a SaaS platform for hosting a service or micro service for use by a user device, as described herein. Along those lines, network 400 may include one or more mobile phones, pads/tablets, notebooks, and/or other web-usable devices 401 in wired and/or wireless communication with a wired and/or wireless access point (“AP”) 403 connected to or of a wireless router. Furthermore, one or more of such web-usable wireless devices 401 may be in wireless communication with a base station 413.

Additionally, a desktop computer and/or a printing device, such as for example one or more multi-function printer (“MFPs”) 402, each of which may be web-usable devices, may be in wireless and/or wired communication to and from router 404. An MFP 402 may include at least one plasma head as previously described herein.

Wireless AP 403 may be connected for communication with a router 404, which in turn may be connected to a modem 405. Modem 405 and base station 413 may be in communication with an Internet-Cloud infrastructure 407, which may include public and/or private networks.

A firewall 406 may be in communication with such an Internet-Cloud infrastructure 407. Firewall 406 may be in communication with a universal device service server 408. Universal device service server 408 may be in communication with a content server 409, a web server 414, and/or an app server 412. App server 412, as well as a network 400, may be used for downloading an app or one or more components thereof for accessing and using a service or a micro service as described herein.

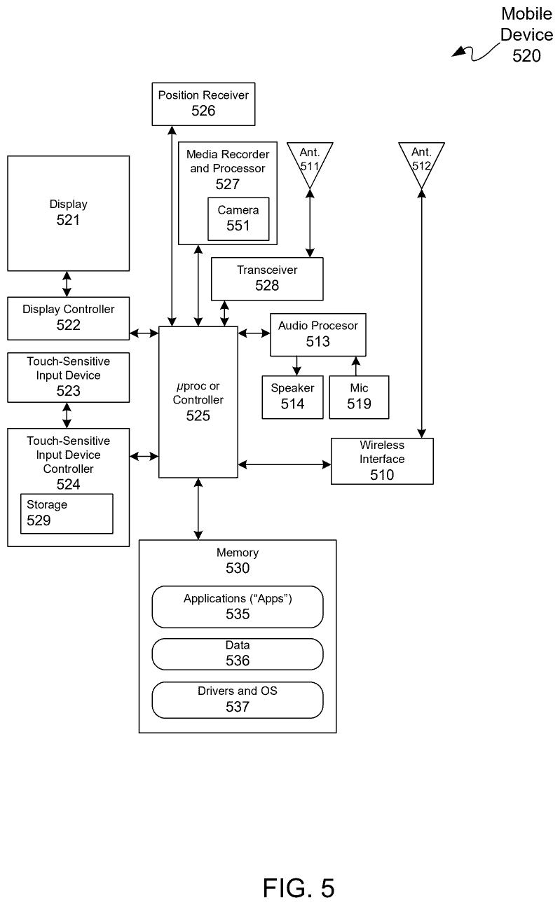

FIG. 5 is a block diagram depicting an example of a portable communication device (“mobile device”) 520. Mobile device 520 may be an example of a mobile device used to instruct a printing device.

Mobile device 520 may include a wireless interface 510, an antenna 511, an antenna 512, an audio processor 513, a speaker 514, and a microphone (“mic”) 519, a display 521, a display controller 522, a touch-sensitive input device 523, a touch-sensitive input device controller 524, a microprocessor or microcontroller 525, a position receiver 526, a media recorder 527, a cell transceiver 528, and a memory or memories (“memory”) 530.

Microprocessor or microcontroller 525 may be programmed to control overall operation of mobile device 520. Microprocessor or microcontroller 525 may include a commercially available or custom microprocessor or microcontroller.

Memory 530 may be interconnected for communication with microprocessor or microcontroller 525 for storing programs and data used by mobile device 520. Memory 530 generally represents an overall hierarchy of memory devices containing software and data used to implement functions of mobile device 520. Data and programs or apps, such as a mobile client application as described hereinabove, may be stored in memory 530.

Memory 530 may include, for example, RAM or other volatile solid-state memory, flash or other non-volatile solid-state memory, a magnetic storage medium such as a hard disk drive, a removable storage media, or other suitable storage means. In addition to handling voice communications, mobile device 520 may be configured to transmit, receive and process data, such as Web data communicated to and from a Web server, text messages (also known as short message service or SMS), electronic mail messages, multimedia messages (also known as MMS), image files, video files, audio files, ring tones, streaming audio, streaming video, data feeds (e.g., podcasts), and so forth.

In this example, memory 530 stores drivers, such as I/O device drivers, and operating system programs (“OS”) 537. Memory 530 stores application programs (“apps”) 535 and data 536. Data may include application program data. Apps 535 may include an XJDF reference file for a hot folder for communicating to a printer system in place of a printer driver.

I/O device drivers may include software routines accessed through microprocessor or microcontroller 525 or by an OS stored in memory 530. Apps, to communicate with devices such as the touch-sensitive input device 523 and keys and other user interface objects adaptively displayed on a display 521, may use one or more of such drivers.

Mobile device 520, such as a mobile or cell phone, includes a display 521. Display 521 may be operatively coupled to and controlled by a display controller 522, which may be a suitable microcontroller or microprocessor programmed with a driver for operating display 521.

Touch-sensitive input device 523 may be operatively coupled to and controlled by a touch-sensitive input device controller 524, which may be a suitable microcontroller or microprocessor. Along those lines, touching activity input via touch-sensitive input device 523 may be communicated to touch-sensitive input device controller 524. Touch-sensitive input device controller 524 may optionally include local storage 529.

Touch-sensitive input device controller 524 may be programmed with a driver or application program interface (“API”) for apps 535. An app may be associated with a service, as previously described herein, for use of a SaaS. One or more aspects of above-described apps may operate in a foreground or background mode.

Microprocessor or microcontroller 525 may be programmed to interface directly touch-sensitive input device 523 or through touch-sensitive input device controller 524. Microprocessor or microcontroller 525 may be programmed or otherwise configured to interface with one or more other interface device(s) of mobile device 520. Microprocessor or microcontroller 525 may be interconnected for interfacing with a transmitter/receiver (“transceiver”) 528, audio processing circuitry, such as an audio processor 513, and a position receiver 526, such as a global positioning system (“GPS”) receiver. An antenna 511 may be coupled to transceiver 528 for bi-directional communication, such as cellular and/or satellite communication.

Mobile device 520 may include a media recorder and processor 527, such as a still camera 551, a video camera, an audio recorder, or the like, to capture digital pictures, audio and/or video. Microprocessor or microcontroller 525 may be interconnected for interfacing with media recorder and processor 527. Image, audio and/or video files corresponding to the pictures, songs and/or video may be stored in memory 530 as data 536.

Mobile device 520 may include an audio processor 513 for processing audio signals, such as for example audio information transmitted by and received from transceiver 528. Microprocessor or microcontroller 525 may be interconnected for interfacing with audio processor 513. Coupled to audio processor 513 may be one or more speakers 514 and one or more microphones 519, for projecting and receiving sound, including without limitation recording sound, via mobile device 520. Audio data may be passed to audio processor 513 for playback. Audio data may include, for example, audio data from an audio file stored in memory 530 as data 536 and retrieved by microprocessor or microcontroller 525. Audio processor 513 may include buffers, decoders, amplifiers and the like.

Mobile device 520 may include one or more local wireless interfaces 510, such as a WIFI interface, an infrared transceiver, and/or an RF adapter. Wireless interface 510 may provide a Bluetooth adapter, a WLAN adapter, an Ultra-Wideband (“UWB”) adapter, and/or the like. Wireless interface 510 may be interconnected to an antenna 512 for communication. As is known, a wireless interface 510 may be used with an accessory, such as for example a hands-free adapter and/or a headset. For example, audible output sound corresponding to audio data may be transferred from mobile device 520 to an adapter, another mobile radio terminal, a computer, or another electronic device. In another example, wireless interface 510 may be for communication within a cellular network or another Wireless Wide-Area Network (WWAN).

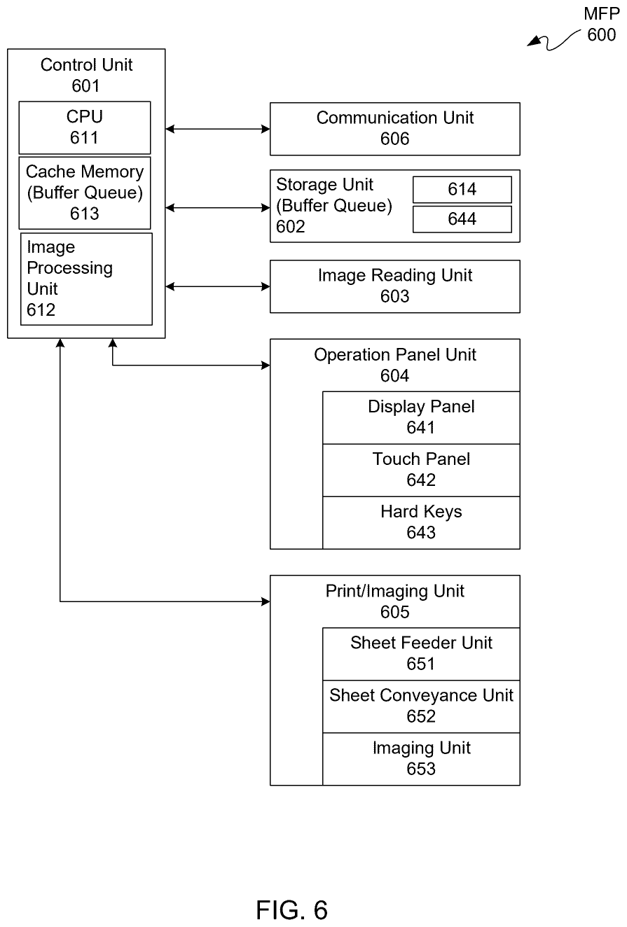

FIG. 6 is a block diagram depicting an example of a multi-function printer MFP 600. MFP 600 is provided for purposes of clarity by way of non-limiting example. MFP 600 is an example of an information processing system such as for handling a printer job.

MFP 600 includes a control unit 601, a storage unit 602, an image reading unit 603, an operation panel unit 604, a print/imaging unit 605, and a communication unit 606. Communication unit 606 may be coupled to a network for communication with other peripherals, mobile devices, computers, servers, and/or other electronic devices. Control unit 601 may include a CPU 611, an image processing unit 612, and cache memory 613.

Control unit 601 may be included with or separate from other components of MFP 600. Storage unit 602 may include ROM, RAM, and large capacity storage memory, such as for example an HDD or an SSD. Storage unit 602 may store various types of data and control programs, including without limitation a printer imaging pipeline program 614 and a printer job settings app 644. A buffer queue may be located in cache memory 613 or storage unit 602.

Operation panel unit 604 may include a display panel 641, a touch panel 642, and hard keys 643. Print/imaging unit 605 may include a sheet feeder unit 651, a sheet conveyance unit 652, and an imaging unit 653.

Generally, for example, for an MFP a copy image processing unit, a scanner image processing unit, and a printer image processing unit may all be coupled to respective direct memory access controllers for communication with a memory controller for communication with a memory. Many known details regarding MFP 600 are not described for purposes of clarity and not limitation.

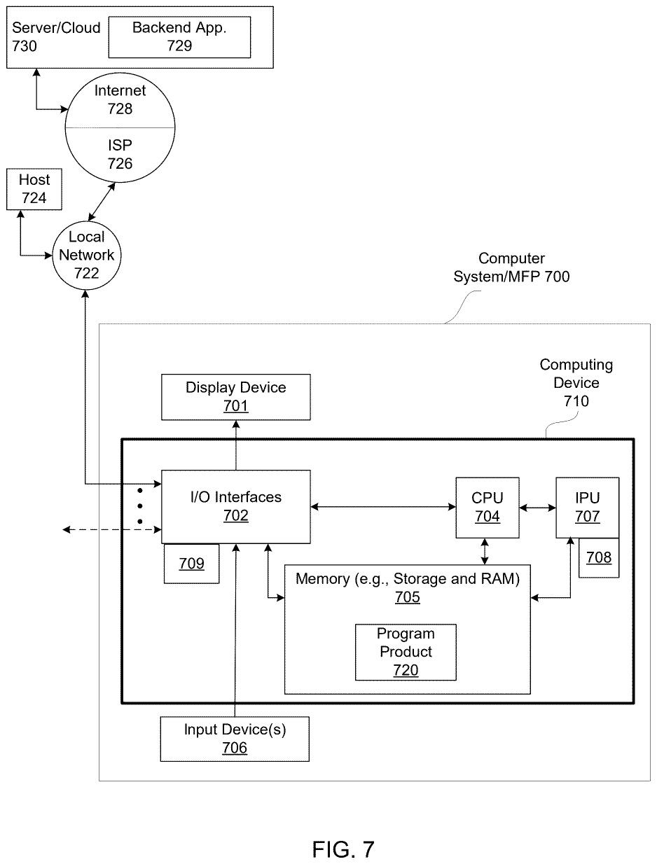

FIG. 7 is a block diagram depicting an example of a computer system or MFP 700 (“computer system”) upon which one or more aspects described herein may be implemented. Computer system 700 may include a programmed computing device 710 coupled to one or more display devices 701, such as Cathode Ray Tube (“CRT”) displays, plasma displays, Liquid Crystal Displays (“LCDs”), Light Emitting Diode (“LED”) displays, light emitting polymer displays (“LPDs”) projectors and to one or more input devices 706, such as a keyboard and a cursor pointing device. Other known configurations of a computer system may be used. Computer system 700 by itself or networked with one or more other computer systems 700 may provide an information handling/processing system.

Programmed computing device 710 may be programmed with a suitable operating system, which may include Mac OS, Java Virtual Machine, Real-Time OS Linux, Solaris, iOS, Darwin, Android Linux-based OS, Linux, OS-X, UNIX, or a Windows operating system, among other platforms, including without limitation an embedded operating system, such as VxWorks. Programmed computing device 710 includes a central processing unit (“CPU”) 704, one or more memories and/or storage devices (“memory”) 705, and one or more input/output (“I/O”) interfaces (“I/O interface”) 702. Programmed computing device 710 may optionally include an image processing unit (“IPU”) 707 coupled to CPU 704 and one or more peripheral cards 709 coupled to I/O interface 702. Along those lines, programmed computing device 710 may include graphics memory 708 coupled to optional IPU 707.

CPU 704 may be a type of microprocessor known in the art, such as available from IBM, Intel, ARM, and Advanced Micro Devices for example. CPU 704 may include one or more processing cores. Support circuits (not shown) may include busses, cache, power supplies, clock circuits, data registers, and the like.

Memory 705 may be directly coupled to CPU 704 or coupled through I/O interface 702. At least a portion of an operating system may be disposed in memory 705. Memory 705 may include one or more of the following: flash memory, random access memory, read only memory, magneto-resistive read/write memory, optical read/write memory, cache memory, magnetic read/write memory, and the like, as well as non-transitory signal-bearing media as described below. For example, memory 705 may include an SSD, which is coupled to I/O interface 702, such as through an NVMe-PCIe bus, SATA bus or other bus. Moreover, one or more SSDs may be used, such as for NVMe, RAID or other multiple drive storage for example.

I/O interface 702 may include chip set chips, graphics processors, and/or daughter cards, among other known circuits. In this example, I/O interface 702 may be a Platform Controller Hub (“PCH”). I/O interface 702 may be coupled to a conventional keyboard, network, mouse, camera, microphone, display printer, and interface circuitry adapted to receive and transmit data, such as data files and the like.

Programmed computing device 710 may optionally include one or more peripheral cards 709. An example of a daughter or peripheral card may include a network interface card (“NIC”), a display interface card, a modem card, and a Universal Serial Bus (“USB”) interface card, among other known circuits. Optionally, one or more of these peripherals may be incorporated into a motherboard hosting CPU 704 and I/O interface 702. Along those lines, IPU 707 may be incorporated into CPU 704 and/or may be of a separate peripheral card.

Programmed computing device 710 may be coupled to a number of client computers, server computers, or any combination thereof via a conventional network infrastructure, such as a company's Intranet and/or the Internet, for example, allowing distributed use. Moreover, a storage device, such as an SSD for example, may be directly coupled to such a network as a network drive, without having to be directly internally or externally coupled to programmed computing device 710. However, for purposes of clarity and not limitation, it shall be assumed that an SSD is housed in programmed computing device 710.

Memory 705 may store all or portions of one or more programs or data, including variables or intermediate information during execution of instructions by CPU 704, to implement processes in accordance with one or more examples hereof to provide a program product 720. Program product 720 may be for implementing portions of process flows, as described herein. Additionally, those skilled in the art will appreciate that one or more examples hereof may be implemented in hardware, software, or a combination of hardware and software. Such implementations may include a number of processors or processor cores independently executing various programs, dedicated hardware and/or programmable hardware.

Along those lines, implementations related to use of computing device 710 for implementing techniques described herein may be performed by computing device 710 in response to CPU 704 executing one or more sequences of one or more instructions contained in main memory of memory 705. Such instructions may be read into such main memory from another machine-readable medium, such as a storage device of memory 705. Execution of the sequences of instructions contained in main memory may cause CPU 704 to perform one or more process steps described herein. In alternative implementations, hardwired circuitry may be used in place of or in combination with software instructions for such implementations. Thus, the example implementations described herein should not be considered limited to any specific combination of hardware circuitry and software, unless expressly stated herein otherwise.

One or more program(s) of program product 720, as well as documents thereof, may define functions of examples hereof and can be contained on a variety of non-transitory tangible signal-bearing media, such as computer-or machine-readable media having code, which include, but are not limited to: (i) information permanently stored on non-writable storage media (e.g., read-only memory devices within a computer such as CD-ROM or DVD-ROM disks readable by a CD-ROM drive or a DVD drive); or (ii) alterable information stored on writable storage media (e.g., floppy disks within a diskette drive or flash drive or hard-disk drive or read/writable CD or read/writable DVD).

Computer readable storage media encoded with program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. In implementations, information downloaded from the Internet and other networks may be used to provide program product 720. Such transitory tangible signal-bearing media, when carrying computer-readable instructions that direct functions hereof, represent implementations hereof.

Along those lines the term “tangible machine-readable medium” or “tangible computer-readable storage” or the like refers to any tangible medium that participates in providing data that causes a machine to operate in a specific manner. In an example implemented using computer system 700, tangible machine-readable media are involved, for example, in providing instructions to CPU 704 for execution as part of programmed product 720. Thus, a programmed computing device 710 may include programmed product 720 embodied in a tangible machine-readable medium. Such a medium may take many forms, including those describe above.

The term “transmission media”, which includes coaxial cables, conductive wire and fiber optics, including traces or wires of a bus, may be used in communication of signals, including a carrier wave or any other transmission medium from which a computer can read. Transmission media can also take the form of acoustic or light waves, such as those generated during radio-wave and infra-red data communications.

Various forms of tangible signal-bearing machine-readable media may be involved in carrying one or more sequences of one or more instructions to CPU 704 for execution. For example, instructions may initially be carried on a magnetic disk or other storage media of a remote computer. The remote computer can load the instructions into its dynamic memory and send such instructions over a transmission media using a modem. A modem local to computer system 700 can receive such instructions on such transmission media and use an infra-red transmitter to convert such instructions to an infra-red signal. An infra-red detector can receive such instructions carried in such infra-red signal and appropriate circuitry can place such instructions on a bus of computing device 710 for writing into main memory, from which CPU 704 can retrieve and execute such instructions. Instructions received by main memory may optionally be stored on a storage device either before or after execution by CPU 704.

Computer system 700 may include a communication interface as part of I/O interface 702 coupled to a bus of computing device 710. Such a communication interface may provide a two-way data communication coupling to a network link connected to a local network 722. For example, such a communication interface may be a local area network (“LAN”) card to provide a data communication connection to a compatible LAN. Wireless links may also be implemented. In any such implementation, a communication interface sends and receives electrical, electromagnetic or optical signals that carry digital and/or analog data and instructions in streams representing various types of information.

A network link to local network 722 may provide data communication through one or more networks to other data devices. For example, a network link may provide a connection through local network 722 to a host computer 724 or to data equipment operated by an Internet Service Provider (“ISP”) 726 or another Internet service provider. ISP 726 may in turn provide data communication services through a world-wide packet data communication network, the “Internet” 728. Local network 722 and the Internet 728 may both use electrical, electromagnetic or optical signals that carry analog and/or digital data streams. Data carrying signals through various networks, which carry data to and from computer system 700, are exemplary forms of carrier waves for transporting information.

Wireless circuitry of I/O interface 702 may be used to send and receive information over a wireless link or network to one or more other devices'conventional circuitry such as an antenna system, an RF transceiver, one or more amplifiers, a tuner, one or more oscillators, a digital signal processor, a CODEC chipset, memory, and the like. In some implementations, wireless circuitry may be capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, WIFI (such as IEEE 802.11a, IEEE 802.11b, IEEE 802.11g and/or IEEE 802.11n), Bluetooth, Wi-MAX, voice over Internet Protocol (VoIP), near field communication protocol (NFC), a protocol for email, instant messaging, and/or a short message service (SMS), or any other suitable communication protocol. A computing device can include wireless circuitry that can communicate over several different types of wireless networks depending on the range required for the communication. For example, a short-range wireless transceiver (e.g., Bluetooth), a medium-range wireless transceiver (e.g., WIFI), and/or a long range wireless transceiver (e.g., GSM/GPRS, UMTS, CDMA2000, EV-DO, and LTE/LTE-Advanced) can be used depending on the type of communication or the range of the communication.

Computer system 700 can send messages and receive data, including program code, through network(s) via a network link and communication interface of I/O interface 702. In the Internet example, a server 730 might transmit a requested code for an application program through Internet 728, ISP 726, local network 722 and I/O interface 702. A server/Cloud-based system 730 may include a backend application for providing one or more applications or services as described herein. Received code may be executed by processor 704 as it is received, and/or stored in a storage device, or other non-volatile storage, of memory 705 for later execution. In this manner, computer system 700 may obtain application code in the form of a carrier wave.

While the foregoing describes exemplary apparatus(es) and/or method(s), other and further examples in accordance with the one or more aspects described herein may be devised without departing from the scope hereof, which is determined by the claims that follow and equivalents thereof. Claims listing steps do not imply any order of the steps. Trademarks are the property of their respective owners.

What is claimed is:

1. A method for a printing device, comprising:
receiving a print job by a job manager of a digital front end of the printing device;
subscribing by an exchange job definition formatted client (“client”) to receive associated signal information regarding the print job;
providing the print job under control of the job manager to a printer engine and task report device of the digital front end;
queuing an exchange job definition message for a printing thread associated with the print job in a message queue of the digital front end for a forward path to the client;
monitoring the message queue and a signal queue by a task monitor of the digital front end;
passing the exchange job definition message from the message queue to a task processor of the digital front end;
processing the exchange job definition message responsive to content thereof by the task processor;
receiving a subscription for the client via the task processor by a subscription manager of the digital front end; and
creating a combined message by the subscription manager using the subscription and an associated address for the client.

2. The method according to claim 1, wherein the receiving of the print job is by streaming to the printer engine and task report device of the digital front end.

3. The method according to claim 1, wherein the receiving of the print job is to a hotfolder accessible by the digital front end.

4. The method according to claim 1, wherein the message queue and the exchange job definition message respectively are a first message queue and a first exchange job definition message, the method further comprising queuing a second exchange job definition message in a second message queue feeding a background path for a job audit function.

5. The method according to claim 1, wherein the exchange job definition formatted client is an Exchange Job Definition Format (XJDF) client.

6. The method according to claim 5, wherein the Exchange Job Definition Format (XJDF) client is a web presence.

7. The method according to claim 5, further comprising inserting a start clean up message and an end clean up message at opposite ends of the message queue.

8. The method according to claim 5, wherein the task processor receives the subscription for the client via a subscription signal.

9. The method according to claim 8, further comprising:
dispatching signals from the combined message, wherein the combined message is an Exchange Job Definition Message; and
providing the signals dispatched to a thread pool manager of the digital front end.

10. The method according to claim 9, further comprising:
instancing the client by the thread pool manager responsive to the subscription; and
instancing the signal queue by the thread pool manager responsive to the instancing of the client.

11. The method according to claim 9, further comprising:
instancing the client by the thread pool manager responsive to the subscription; and
reassigning the signal queue by the thread pool manager responsive to the instancing of the client.

12. A system, comprising:
a printing device having:
a memory configured to store program code; and
a processor coupled to the memory;
wherein, in combination and response to executing the program code, the printer system is configured to initiate operations for implementing a process for printing, the process including:
receiving a print job by a job manager of a digital front end of the printing device;
subscribing by an exchange job definition formatted client (“client”) to receive associated signal information regarding the print job;
providing the print job under control of the job manager to a printer engine and task report device of the digital front end;
queuing an exchange job definition message for a printing thread associated with the print job in a message queue of the digital front end for a forward path to the client;
monitoring the message queue and a signal queue by a task monitor of the digital front end;
passing the exchange job definition message from the message queue to a task processor of the digital front end;
processing the exchange job definition message responsive to content thereof by the task processor;
receiving a subscription for the client via the task processor by a subscription manager of the digital front end; and
creating a combined message by the subscription manager using the subscription and an associated address for the client.

13. The system according to claim 12, wherein the receiving of the print job is by streaming to the printer engine and task report device of the digital front end.

14. The system according to claim 12, wherein the receiving of the print job is to a hotfolder accessible by the digital front end.

15. The system according to claim 12, wherein the message queue and the exchange job definition message respectively are a first message queue and a first exchange job definition message, the process further including queuing a second exchange job definition message in a second message queue feeding a background path for a job audit function.

16. The system according to claim 12, wherein the exchange job definition formatted client is an Exchange Job Definition Format (“XJDF”) client.

17. The system according to claim 16, wherein the XJDF client is a web presence.

18. The system according to claim 16, further comprising inserting a start clean up message and an end clean up message at opposite ends of the message queue.

19. The system according to claim 16, wherein the task processor receives the subscription for the XJDF client via a subscription signal.

20. The system according to claim 19, wherein the process further includes:
dispatching signals from the combined message, wherein the combined message is an Exchange Job Definition Message (“XJDM”) combined message;
providing the signals dispatched to a thread pool manager of the digital front end;
instancing the client by the thread pool manager responsive to the subscription; and
instancing the signal queue by the thread pool manager responsive to the instancing of the client.
